(19) United States
(12) Patent Application Publication
(10) Pub. No.: US 2025/0029371 A1
(43) Pub. Date: Jan. 23, 2025

(54) DEVICE AND COMPUTER-IMPLEMENTED METHOD FOR DETERMINING A DATA SET FOR USE IN TRAINING, FOR TRAINING AND FOR OPERATING A MACHINE LEARNING SYSTEM

(71) Applicant: Robert Bosch GmbH, Stuttgart (DE)

(72) Inventors: Julio Borges, Stuttgart (DE); Kevin Alexander Laube, Rottenburg Wurmlingen (DE)

(21) Appl. No.: 18/774,215

(22) Filed: Jul. 16, 2024

(30) Foreign Application Priority Data
Jul. 18, 2023 (EP) 23186186.5

(51) Int. Cl. G06V 10/774; G06V 10/764

(52) U.S. Cl. CPC G06V 10/774; G06V 10/764

(57) ABSTRACT

A device and computer-implemented method for determining a data set for use in training a machine learning system. A first and second data set are combined to form the data set for use in training. The first data set includes a first digital image identified by at least one label from a first set of labels. The second data set includes a second digital image identified by at least one label from a second set of labels. The two sets of labels differ by at least one label. A first encoding for identifying the first digital image is determined with labels from both sets of labels. The first encoding is mapped to a first representation in a state space. The data set for use in training includes the first digital image and the first representation.

### FIELD

The present invention relates to a device and a computer-implemented method for determining a data set for use in training a machine learning system, for training the machine learning system and for operating the machine learning system.

### SUMMARY

According to an example embodiment of the present invention, a computer-implemented method for determining a data set for use in training a machine learning system provides that at least two data sets are combined to form the data set for use in training, wherein the at least two data sets comprise a first data set and a second data set, wherein the first data set comprises a first digital image, which is identified by at least one label, in particular by a one-hot encoding with one label or by a multi-hot encoding with a plurality of labels, from a first set of labels, and the second data set comprises a second digital image, which is identified by at least one label, in particular by a one-hot encoding with one label or by a multi-hot encoding with a plurality of labels, from a second set of labels, wherein the two sets of labels differ by at least one label, wherein, depending on the two sets of labels, a first encoding for identifying the first digital image is determined with labels from both sets of labels, wherein the first encoding is mapped to a first representation in a state space, wherein the data set for use in training comprises the first digital image and the first representation. The representation is a continuous representation of at least one label from the union for identifying the first image. The data set for use in training the machine learning system is particularly suitable for training a semantic image synthesis depending on the first representation in the state space and the first image. The semantic image synthesis takes place, for example, with a generative model designed to map the first representation to a synthetic digital image.

According to an example embodiment of the present invention, it may be provided that, depending on the two sets of labels, a second encoding for identifying the second digital image is determined with labels from both sets of labels, wherein the second encoding is mapped to a second representation in the state space, wherein the data set for use in training comprises the second digital image and the second representation. This makes both images and the representations respectively assigned to them available for training the machine learning system, in particular for semantic image synthesis.

According to an example embodiment of the present invention, a computer-implemented method for training a machine learning system provides that a data set for use in training is determined with the method for determining a data set for use in training the machine learning system, wherein the system comprises a model designed to map at least one label, in particular a one-hot encoding of one label or a multi-hot encoding of a plurality of labels, to a representation of the at least one label in the state space provided in the data set for use in training and to map the representation from the state space to a synthetic digital image, wherein the model is trained with the first representation and the first digital image and/or with the second representation and the second digital image from the data set to map the representation from the state space to the synthetic digital image, or wherein the model is designed to map a digital image to a representation of at least one label in the state space provided in the data set for use in training and, depending on the representation from the state space, to determine the at least one label, in particular a one-hot encoding of one label or a multi-hot encoding of a plurality of labels, for the digital image, wherein the model is trained with the first representation and the first digital image and/or with the second representation and the second digital image from the data set to map the digital image to the representation in the state space. This means that the model is trained with a representation of at least one combined label, e.g., for semantic image synthesis.

According to an example embodiment of the present invention, a computer-implemented method for operating a machine learning system provides that the machine learning system comprises a model designed to map at least one label for a synthetic digital image, in particular a one-hot encoding of one label or a multi-hot encoding of a plurality of labels, to a representation of the at least one label in the state space provided in the data set for use in training, and to map the representation from the state space to the synthetic digital image, or to determine at least one label, in particular a one-hot encoding of one label or a multi-hot encoding of a plurality of labels, for a digital image, wherein the model is trained with the method for training, wherein, with the model, the at least one label is mapped to a representation of the at least one label in the state space and the representation in the state space is mapped to the synthetic digital image, or wherein, with the model, the at least one label for a digital image is determined. This means that the model is trained with a representation of at least one combined label, e.g., for semantic image synthesis. Depending on synthetic digital images generated by the model and/or depending on the labels, the model can be trained to label, in particular to classify or to semantically segment, the synthetic digital image.

According to an example embodiment of the present invention, it may be provided that the machine learning system comprises a technical system designed for at least partially autonomous operation depending on at least one label, in particular a one-hot encoding of one label or a multi-hot encoding of a plurality of labels, for a digital image, wherein the digital image is captured in the method for operating the machine learning system, wherein the at least one label for the digital image is determined with the model, and wherein the technical system is operated at least partially autonomously depending on the at least one label for the digital image. This means that the system with the trained model responds autonomously to previously unknown digital images.

According to an example embodiment of the present invention, a device for determining a data set for use in training a machine learning system, comprising at least one processor and at least one memory, wherein the at least one memory comprises instructions that can be executed by the at least one processor and that, when they are executed by the at least one processor, cause the device to perform the method for determining the data set according to the present invention, wherein the at least one processor is designed to execute the instructions, has advantages corresponding to the advantages of the method for determining the data set.

According to an example embodiment of the present invention, a device for training a machine learning system, the device comprising at least one processor and at least one memory, wherein the at least one memory comprises instructions that can be executed by the at least one processor and that, when they are executed by the at least one processor, cause the device to perform the method for training the machine learning system according to the present invention, wherein the at least one processor is designed to execute the instructions, has advantages corresponding to the advantages of the method for training the machine learning system.

According to an example embodiment of the present invention, a device for operating a machine learning system, comprising at least one processor and at least one memory, wherein the at least one memory comprises instructions that can be executed by the at least one processor and that, when they are executed by the at least one processor, cause the device to perform the method for operating the machine learning system according to the present invention, wherein the at least one processor is designed to execute the instructions, has advantages corresponding to the advantages of the method for operating the machine learning system.

According to an example embodiment of the present invention, a computer program comprising instructions that can be executed by a computer and that, when they are executed by the computer, cause the method according to the present invention to run has advantages corresponding to the advantages of the method.

Further advantageous embodiments of the present invention can be found in the disclosure herein.

### BRIEF DESCRIPTION OF THE DRAWINGS

FIG. 1 shows a schematic representation of a device for determining a data set, according to an example embodiment of the present invention.

FIG. 2 shows a schematic representation of data sets, according to an example embodiment of the present invention.

FIG. 3 shows a flowchart with steps of a computer-implemented method for determining the data set, according to an example embodiment of the present invention.

FIG. 4 shows a schematic representation of a device for training a machine learning system, according to an example embodiment of the present invention.

FIG. 5 shows a flowchart with steps of a computer-implemented method for training the machine learning system, according to an example embodiment of the present invention.

FIG. 6 shows a schematic representation of a device for operating the machine learning system, according to an example embodiment of the present invention.

FIG. 7 shows a flowchart with steps of a computer-implemented method for operating the machine learning system, according to an example embodiment of the present invention.

### DETAILED DESCRIPTION OF EXAMPLE EMBODIMENTS

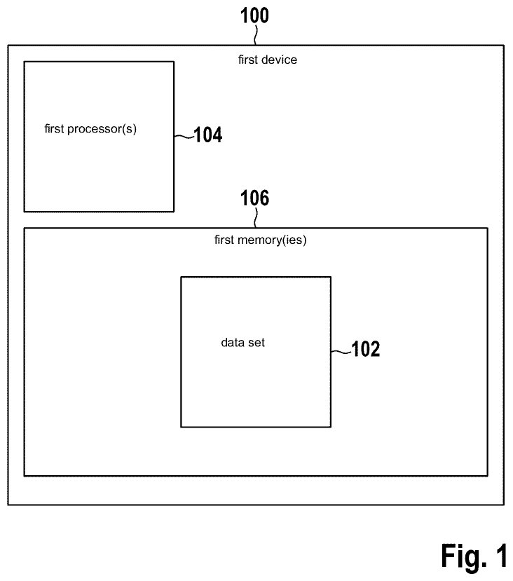

FIG. 1 shows a schematic representation of a first device 100. The first device is designed to determine a data set 102 for use in training.

The first device 100 comprises at least one first processor 104 and at least one first memory 106.

The at least one first memory 106 comprises instructions that can be executed by the at least one first processor 104 and that, when they are executed by the at least one first processor 104, cause the first device 100 to perform a method for determining the data set 102 for use in training. The at least one first processor 104 is designed to execute these instructions. In the example, the data set 102 for use in training is stored in the at least one first memory 106.

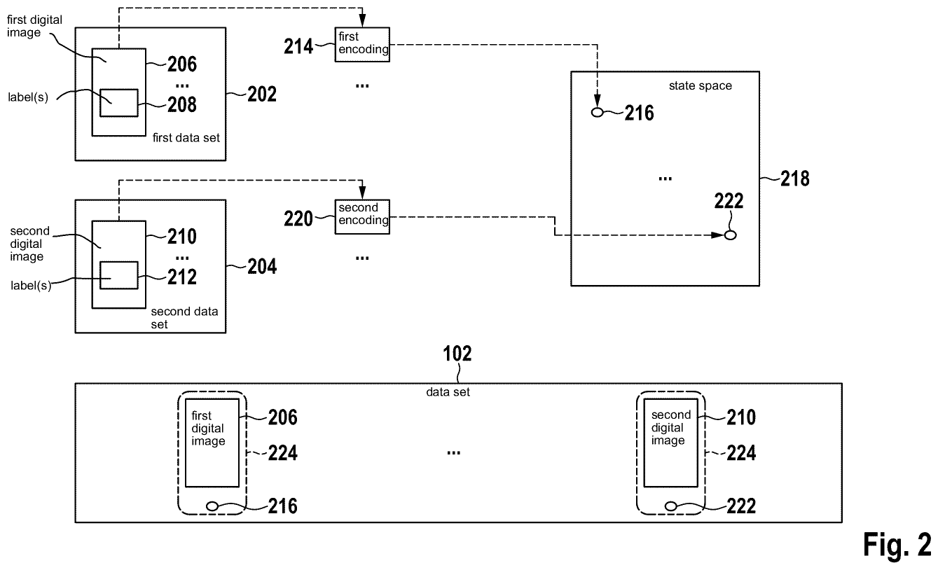

FIG. 2 shows an architecture for determining the data set 102 for use in training. The data set 102 for use in training is determined depending on at least two data sets. This is described using the example of determining the data set 102 for use in training depending on a first data set 202 and a second data set 204.

An example of the first data set 202 is Berkeley DeepDrive, BDD. An example of the second data set 204 is Cityscapes.

The first data set 202 comprises digital images, each of which is assigned at least one label, which identifies the relevant digital image. In the example, a first digital image 206, which is identified by at least one label 208, is provided. The first image 206 in the example is identified by a one-hot encoding with one label or by a multi-hot encoding with a plurality of labels. For the first image 206, a first set of labels is provided, which comprises the label or labels for the first image.

The labels from the first set of N labels each identify a class. In one-hot encoding, a class is mapped to a vector {0,1}^{N}, which contains exactly one one and otherwise zeros. For example, the elements of a vector representing a particular class are each assigned to a class, wherein the element assigned to the particular class represented by the vector is one. In multi-hot encoding, it is allowed that a plurality of the elements of the vector are one, i.e., the vector can represent a plurality of classes.

An example of the first set of labels is two-wheeler, automobile, background person. An exemplary first digital image 206 shows a two-wheeler. An exemplary first label 208 is two-wheeler. An example of a one-hot encoding of the exemplary first digital image 206 is a vector [1, 0, 0, 0], which represents the exemplary first label 208 “two-wheeler”.

The second data set 204 comprises digital images, each of which is assigned at least one label, which identifies the relevant digital image. In the example, a second digital image 210, which is identified by at least one label 212, is provided. The second digital image 210 in the example is identified by a one-hot encoding with one label or by a multi-hot encoding with a plurality of labels. For the second image 210, a second set of labels is provided, which comprises the label or labels for the second digital image 210.

The labels from the second set of M labels each identify a class. In one-hot encoding, a class is mapped to a vector {0,1}^{M}, which contains exactly one one and otherwise zeros. For example, the elements of a vector representing a particular class are each assigned to a class, wherein the element assigned to the particular class represented by the vector is one. In multi-hot encoding, it is allowed that a plurality of the elements of the vector are one, i.e., the vector can represent a plurality of classes.

An example of the second set of labels is sky, vegetation, person, vehicle. An exemplary second digital image 210 shows a person. An exemplary second label 212 is person. An example of a one-hot encoding of the exemplary second digital image 210 is a vector [0, 0, 1, 0], which represents the exemplary second label 212 “person”.

The two sets of labels in the example differed by at least one label. In the example, N=M=4 labels are provided in both sets of labels. The number of labels in the two sets may also be different.

The digital images from the first data set 202 are each assigned an encoding, which encodes labels from both sets, for identifying the relevant digital image. The first digital image 206 is assigned a first encoding 214 for identifying the first digital image 206. The first encoding 214 encodes labels from both sets. This is described by way of example for the first digital image 206.

The labels contained in both sets are summarized in the first encoding 214. In the example, the first encoding 214 comprises the labels of the two sets that differ from one another. In the example, the order in which the labels are contained in the first encoding 214 corresponds to the order in which the labels are arranged in the first set of labels, followed by the labels from the second set of labels that differ from those in the first set of labels, in the order in which the labels that differ from the first set of labels are arranged in the second set of labels. A different order is likewise possible.

The first encoding 214 of the exemplary first digital image 206 is a vector [1, 0, 0, 0, 0, 0, 0] whose elements are assigned to the labels two-wheeler, automobile, background, person, sky, vegetation and vehicle.

The digital images from the second data set 204 are each assigned an encoding, which encodes labels from both sets, for identifying the relevant digital image. This is described by way of example for the second digital image 210.

The second digital image 210 is assigned a second encoding 220 for identifying the second digital image 210. The second encoding 220 encodes labels from both sets.

The labels contained in both sets are summarized in the second encoding 220, as described for the first encoding 214. The second encoding 220 of the exemplary second digital image 210 is a vector [0, 0, 0, 1, 0, 0, 0].

It may be provided that the first encoding 214 is generated depending on the labels from the two sets of labels. For example, a semantic assignment of the labels from the two sets is specified. The semantic assignment is determined, for example, by an expert or with a model designed to assign the labels to one another. An example of the model is WordNet, which is described in Redmon et al., “YOLO9000: Better, Faster, Stronger” (arxiv 1612.08242).

For example, the label “two-wheeler” and the label “vehicle” are assigned to one another in the semantic assignment. An exemplary first encoding 214 for the first digital image 206 is a multi-hot encoding, i.e., a vector [1, 0, 0, 0, 0, 1].

The first encoding 214 is represented by a first representation 216 in a state space 218.

The first representation 216 for the first encoding 214 of the exemplary first digital image 206 is a first vector [0.0232, 0.1, 0.43] in the state space 218.

The second encoding 220 is represented by a second representation 222 in the state space 218.

The second representation 222 for the second encoding 216 of the exemplary second digital image 210 is a second vector [0.73, −0.21, −0.113] in the state space 218.

The encodings for the other digital images in the example are each represented by a representation of the relevant encoding in the state space 218.

In the example, the data set 102 for use in training comprises the first digital image 206 and the first representation 216 as well as the second digital image 210 and the second representation 222. The first digital image 206 and the first representation 216 are assigned to one another as a first training data point 224. The second digital image 210 and the second representation 222 are assigned to one another as a second training data point 226.

The first data set 202 and the second data set 204 are combined with a computer-implemented method for determining the data set 102 for use in training.

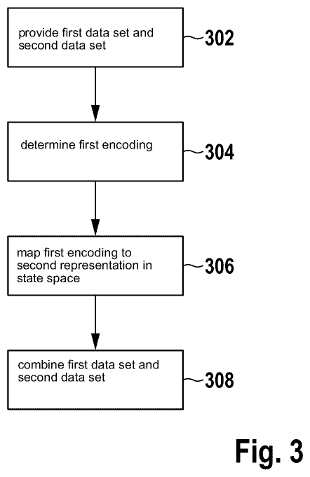

FIG. 3 shows a flowchart with steps of a computer-implemented first method. The first method is provided for determining the data set 102 for use in training. The first method is described using the example of the first digital image 206 and of the second digital image 210. The first method is correspondingly performed for the other digital images.

The first method comprises a step 302.

In step 302, the first data set 202 and the second data set 204 are provided.

A step 304 is subsequently performed.

In step 304, depending on the two sets of labels, the first encoding 214 for identifying the first digital image 206 is determined with labels from both sets of labels.

In step 304, depending on the two sets of labels, the second encoding 218 for identifying the second digital image 210 is optionally determined with labels from both sets of labels.

A step 306 is subsequently performed.

In step 306, the first encoding 214 is mapped to the first representation 216 in the state space 218.

In step 306, the second encoding 220 is optionally mapped to the second representation 222 in the state space 218.

In step 308, the first data set 202 and the second data set 204 are combined to form the data set 102 for use in training.

The data set 102 for use in training comprises the first digital image 206 and the first representation 216.

Optionally, the data set 102 for use in training comprises the second digital image 210 and the second representation 222.

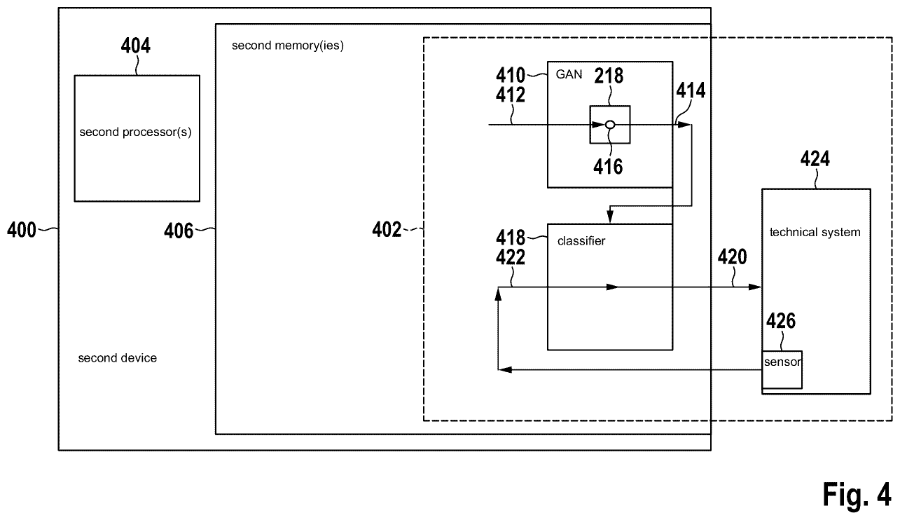

FIG. 4 shows a schematic representation of a second device 400. The second device 400 is designed to train a machine learning system 402.

The second device 400 comprises at least one second processor 404 and at least one second memory 406.

The at least one second memory 406 comprises instructions that can be executed by the at least one second processor 404 and that, when they are executed by the at least one second processor 404, cause the second device 400 to perform a method for training. The at least one second processor 404 is designed to execute these instructions. In the example, the second device 400 comprises the machine learning system 402. In the example, the at least one second memory 406 comprises a part of the machine learning system 402.

The machine learning system 402 comprises a model. In the example, the model comprises a generative adversarial network GAN 410, which is designed for semantic image synthesis. The GAN 410 is designed to map at least one label 412 for a synthetic or real digital image 414 to a representation 416 of the at least one label 412 in the state space 218. The at least one label 412 for the synthetic or real digital image 414 is, for example, a one-hot encoding of one label or a multi-hot encoding of a plurality of labels. The term “real image” refers to a digital image that reproduces an actually existing view.

The GAN 410 is designed, for example, to determine the relevant representation in the state space 218 by a linear projection of the relevant encoding. The GAN 410 comprises, for example, an encoder for the state space 218 or uses knowledge of an already trained language model such as Vord2Vec.

The GAN 410 is designed to map the representation 416 from the state space 218 to the synthetic digital image 414.

The GAN 410 comprises, for example, an already trained neural network.

It may be provided that the model comprises a classifier 418. The classifier 418 is designed to determine at least one label 420, in particular a one-hot encoding of one label or a multi-hot encoding of a plurality of labels, for the synthetic digital image 414 or for a digital image 422. The classifier comprises, for example, an already trained neural network.

It may be provided that the machine learning system 402 comprises a technical system 424 designed for at least partially autonomous operation depending on the at least one label 420 for the digital image 422.

The technical system 424 is, for example, a physical system. The technical system 424 is, for example, a robot, in particular an autonomous vehicle or a household appliance or a tool or a manufacturing machine or a personal assistance system or an access control system.

The technical system 424 comprises, for example, a sensor 426 designed to capture the digital image 422. The sensor 426 is, for example, a camera, a radar sensor, a LiDAR sensor, an ultrasonic sensor, an infrared sensor, a motion sensor or a thermal imaging sensor.

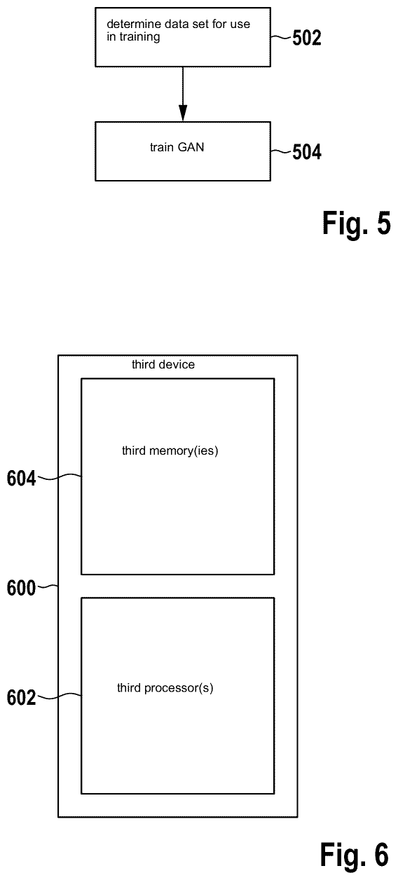

FIG. 5 shows a flowchart with steps of a computer-implemented second method. The second method is provided for training the machine learning system 402.

The training may comprise training the GAN 410 alone, training the classifier 418 alone, or jointly training the GAN 410 and classifier 418 with the data set 102 for use in training.

The second method is described using the example of the first digital image 206 and of the second digital image 210. The second method is correspondingly performed for the other digital images.

The second method for training the system 402 comprises a step 502.

In step 502, the data set 102 for use in training is determined with the first method.

A step 504 is subsequently performed.

In step 504, the GAN 410 is trained with the first representation 216 and the first digital image 206 from the data set 102 for use in training.

The GAN 410 is trained to map the representation 416 from the state space 218 to the synthetic digital image 414.

The GAN 410 is optionally trained with the second representation 222 and the second digital image 210 from the data set 102 for use in training.

This means that, in the example, the GAN 410 alone is trained with the data set 102 for use in training.

FIG. 6 shows a schematic representation of a third device 500. The third device 500 is designed to operate the machine learning system 302.

The third device 600 comprises at least one third processor 602 and at least one third memory 604.

The at least one third memory 604 comprises instructions that can be executed by the at least one third processor 602 and that, when they are executed by the at least one third processor 602, cause the third device 600 to perform a method for machine learning. The at least one third processor 602 is designed to execute these instructions.

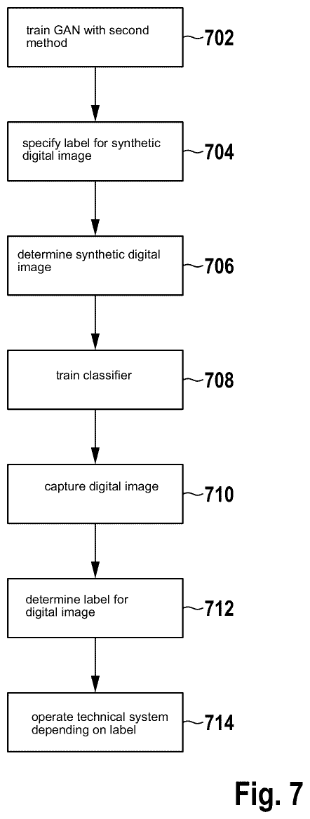

FIG. 7 shows a flowchart with steps of a computer-implemented third method. The third method is provided for machine learning, in particular for operating the machine learning system 402.

The third method comprises a step 702.

In step 702, the GAN 410 is trained with the second method.

A step 704 is subsequently performed.

In step 704, the at least one label 412 for the synthetic digital image 414 for training the classifier 418 is specified.

A step 706 is subsequently performed.

In step 706, the synthetic digital image 414 is determined with the GAN 410 depending on the at least one label 412 for the synthetic digital image 414.

A step 708 is subsequently performed.

In step 708, the classifier 418 is trained depending on the synthetic digital image 414 to determine the at least one label 412 for the synthetic digital image 414.

It may be provided that the classifier 418 or the GAN 410 are already trained. It may be provided that only the classifier 418 alone or only the GAN 410 alone is trained.

Optionally, a step 710 is subsequently performed.

In step 710, the digital image 422 is captured.

Optionally, a step 712 is subsequently performed.

In step 712, the at least one label 420 for the digital image 422 is determined with the classifier 418.

Optionally, a step 714 is subsequently performed.

In step 714, the technical system 424 is operated at least partially autonomously depending on the at least one label 420 for the digital image 422.

The methods are each implemented, for example, as a computer program comprising instructions that can be executed by a computer and that, when they are executed by the computer, cause the relevant method to run.

1-9. (canceled)

10. A computer-implemented method, comprising:
determining a data set for use in training a machine learning system, the determining of the data set including:
combining at least two data sets to form the data set for use in training, wherein the at least two data sets include a first data set and a second data set, wherein the first data set includes a first digital image which is identified by a one-hot encoding with one label or by a multi-hot encoding with a plurality of labels, from a first set of labels, and the second data includes a second digital image which is identified by a one-hot encoding with one label or by a multi-hot encoding with a plurality of labels, from a second set of labels, wherein the first set of labels and the second set of labels differ by at least one label, wherein, depending on the first set of labels and the second set of labels, a first encoding for identifying the first digital image is determined with labels from the first set of labels and the second set of labels, and the first encoding is mapped to a first representation in a state space, wherein the data set for use in training includes the first digital image and the first representation.

11. The method according to claim 10, wherein, depending on the first set of labels and the second set of labels, a second encoding for identifying the second digital image is determined with labels from the first set of labels and the second set of labels, wherein the second encoding is mapped to a second representation in the state space, wherein the data set for use in training includes the second digital image and the second representation.

12. The method according to claim 10, further comprising:
training the machine learning system using the determined data set for use in training, wherein the machine learning system includes a model:
configured to map at least one label including a one-hot encoding of a label or a multi-hot encoding of a plurality of labels, to a representation of the at least one label in the state space provided in the data set for use in training, and to map the representation of the at least one label from the state space to a synthetic digital image, wherein the model is trained with the first representation and the first digital image from the data set and/or with the second representation and the second digital image from the data set, to map the representation from the state space to the synthetic digital image, or
configured to map a digital image to a representation of at least one label in the state space provided in the data set for use in training and to determine the representation of the at least one label from the state space to the at least one label including a one-hot encoding of one label or a multi-hot encoding of a plurality of labels, for the digital image, wherein the model is trained with the first representation and the first digital image from the data set and/or with the second representation and the second digital image from the data set, to map the digital image to the representation in the state space.

13. The method according to claim 12, further comprising:
operating the trained machine learning system, wherein:
with the model, the at least one label is mapped to the representation of the at least one label in the state space and the representation of the at least one label in the state space is mapped to the synthetic digital image, or
with the model, the at least one label for the digital image is determined.

14. The method according to claim 13, wherein the machine learning system includes a technical system configured for at least partially autonomous operation depending on at least one label, the at least one label including a one-hot encoding of one label or a multi-hot encoding of a plurality of labels, for a captured digital image, wherein the at least one label for the captured digital image is determined with the model, and wherein the technical system is operated at least partially autonomously depending on the at least one label for the digital image.

15. A device configured to determine a data set for use in training a machine learning system, the device comprising:
at least one processor; and
at least one memory, wherein the at least one memory stores instructions determining the data set for use in the training of the machine learning system, the instructions, when executed by the at least one processor, causing the at least one processor to perform:
combining at least two data sets to form the data set for use in training, wherein the at least two data sets include a first data set and a second data set, wherein the first data set includes a first digital image which is identified by a one-hot encoding with one label or by a multi-hot encoding with a plurality of labels, from a first set of labels, and the second data includes a second digital image which is identified by a one-hot encoding with one label or by a multi-hot encoding with a plurality of labels, from a second set of labels, wherein the first set of labels and the second set of labels differ by at least one label, wherein, depending on the first set of labels and the second set of labels, a first encoding for identifying the first digital image is determined with labels from the first set of labels and the second set of labels, and the first encoding is mapped to a first representation in a state space, wherein the data set for use in training includes the first digital image and the first representation.

16. A device for training a machine learning system, comprising:
at least one processor; and
at least one memory, wherein the at least one memory stores instructions for training the machine learning system, the instructions, when executed by the at least one processor, causing the at least one processor to train the machine learning model using a determined data set for use in training, the data set for use in training having been determined by:
combining at least two data sets to form the data set for use in training, wherein the at least two data sets include a first data set and a second data set, wherein the first data set includes a first digital image which is identified by a one-hot encoding with one label or by a multi-hot encoding with a plurality of labels, from a first set of labels, and the second data includes a second digital image which is identified by a one-hot encoding with one label or by a multi-hot encoding with a plurality of labels, from a second set of labels, wherein the first set of labels and the second set of labels differ by at least one label, wherein, depending on the first set of labels and the second set of labels, a first encoding for identifying the first digital image is determined with labels from the first set of labels and the second set of labels, and the first encoding is mapped to a first representation in a state space, wherein the data set for use in training includes the first digital image and the first representation;
wherein the machine learning system includes a model:
configured to map at least one label including a one-hot encoding of a label or a multi-hot encoding of a plurality of labels, to a representation of the at least one label in the state space provided in the data set for use in training, and to map the representation of the at least one label from the state space to a synthetic digital image, wherein the model is trained with the first representation and the first digital image from the data set and/or with the second representation and the second digital image from the data set, to map the representation from the state space to the synthetic digital image, or
configured to map a digital image to a representation of at least one label in the state space provided in the data set for use in training and to determine the representation of the at least one label from the state space to the at least one label including a one-hot encoding of one label or a multi-hot encoding of a plurality of labels, for the digital image, wherein the model is trained with the first representation and the first digital image from the data set and/or with the second representation and the second digital image from the data set, to map the digital image to the representation in the state space.

17. A device for operating a machine learning system, the device comprising:
at least one processor; and
at least one memory, wherein the at least one memory which store instructions for operating a trained machine learning system, the machine learning model having been trained using a determined data set for use in training, the data set for use in training having been determined by:
combining at least two data sets to form the data set for use in training, wherein the at least two data sets include a first data set and a second data set, wherein the first data set includes a first digital image which is identified by a one-hot encoding with one label or by a multi-hot encoding with a plurality of labels, from a first set of labels, and the second data includes a second digital image which is identified by a one-hot encoding with one label or by a multi-hot encoding with a plurality of labels, from a second set of labels, wherein the first set of labels and the second set of labels differ by at least one label, wherein, depending on the first set of labels and the second set of labels, a first encoding for identifying the first digital image is determined with labels from the first set of labels and the second set of labels, and the first encoding is mapped to a first representation in a state space, wherein the data set for use in training includes the first digital image and the first representation;
wherein the machine learning system includes a model:
configured to map at least one label including a one-hot encoding of a label or a multi-hot encoding of a plurality of labels, to a representation of the at least one label in the state space provided in the data set for use in training, and to map the representation of the at least one label from the state space to a synthetic digital image, wherein the model is trained with the first representation and the first digital image from the data set and/or with the second representation and the second digital image from the data set, to map the representation from the state space to the synthetic digital image, or
configured to map a digital image to a representation of at least one label in the state space provided in the data set for use in training and to determine the representation of the at least one label from the state space to the at least one label including a one-hot encoding of one label or a multi-hot encoding of a plurality of labels, for the digital image, wherein the model is trained with the first representation and the first digital image from the data set and/or with the second representation and the second digital image from the data set, to map the digital image to the representation in the state space;
wherein the operating of the trained machine learning system includes operating the trained machine learning system:
with the model, the at least one label is mapped to the representation of the at least one label in the state space and the representation of the at least one label in the state space is mapped to the synthetic digital image, or
with the model, the at least one label for the digital image is determined.

18. A non-transitory computer-readable medium on which is stored a computer program including instructions determining a data set for use in training a machine learning system, the instruction, when executed by a computer, causing the compute to perform:
combining at least two data sets to form the data set for use in training, wherein the at least two data sets include a first data set and a second data set, wherein the first data set includes a first digital image which is identified by a one-hot encoding with one label or by a multi-hot encoding with a plurality of labels, from a first set of labels, and the second data includes a second digital image which is identified by a one-hot encoding with one label or by a multi-hot encoding with a plurality of labels, from a second set of labels, wherein the first set of labels and the second set of labels differ by at least one label, wherein, depending on the first set of labels and the second set of labels, a first encoding for identifying the first digital image is determined with labels from the first set of labels and the second set of labels, and the first encoding is mapped to a first representation in a state space, wherein the data set for use in training includes the first digital image and the first representation.
